(19) United States
(12) Patent Application Publication
(10) Pub. No.: US 2026/0046367 A1
(43) Pub. Date: Feb. 12, 2026

(54) SHEET STACKING SECTION AND IMAGE FORMING APPARATUS

(71) Applicant: FUJIFILM Business Innovation Corp., Tokyo (JP)

(72) Inventor: Keita KONTANI, Kanagawa (JP)

(73) Assignee: FUJIFILM Business Innovation Corp., Tokyo (JP)

(21) Appl. No.: 19/082,161

(22) Filed: Mar. 17, 2025

(30) Foreign Application Priority Data
Aug. 6, 2024 (JP) 2024-130196

(51) Int. Cl. H04N 1/00

(52) U.S. Cl. CPC H04N 1/00631; H04N 1/00604; H04N 1/00615; H04N 2201/0094

(57) ABSTRACT

A sheet stacking section includes a stacking portion that extends in one direction and on which a sheet member is stacked, an extension member that rotates about an axis along an intersection direction intersecting the one direction such that one end of the extension member moves on a trajectory upward and that moves between a storage position where the extension member is stored in the stacking portion and an extension position where the extension member protrudes from the stacking portion to extend the stacking portion, and an allowance portion that allows movement of a relative position between the axis and the stacking portion or movement of a relative position between the axis and the extension member such that, in a case where the extension member moves between the storage position and the extension position, a length of the extension member at a portion below a stacking surface of the stacking portion during the movement is longer than the length at beginning of the movement.

### CROSS-REFERENCE TO RELATED APPLICATIONS

This application is based on and claims priority under 35 USC 119 from Japanese Patent Application No. 2024-130196 filed Aug. 6, 2024.

### BACKGROUND

### (i) Technical Field

The present invention relates to a sheet stacking section and an image forming apparatus.

### (ii) Related Art

JP2007-176676A discloses a sheet stacking device including a tray for stacking discharged paper, in which an angle of the paper in the tray can be changed. The angle is changed by changing an angle of a movable member provided on a paper stacking surface of the tray. The movable member may be a single member or a plurality of members, and, in the case of a plurality of members, the movable member to be operated is selected according to a size of the paper.

### SUMMARY

In the related art, the sheet stacking section is provided with a stacking portion on which a sheet member is stacked and an extension member that extends the stacking portion. Specifically, the extension member rotates and moves between a storage position where the extension member is stored in the stacking portion and an extension position where the extension member protrudes from the stacking portion to extend the stacking portion. Here, a relative position between a rotation axis of the extension member and the stacking portion is constant, and a relative position between the extension member and the rotation axis of the extension member is constant.

In such a configuration, one end of the rotating extension member moves on a trajectory above the stacking portion.

Aspects of non-limiting embodiments of the present disclosure relate to a sheet stacking portion and an image forming apparatus that lower a highest position of a trajectory at one end of an extension member as compared with a case where a relative position between a rotation axis of the extension member and a stacking portion is constant and a relative position between the extension member and the rotation axis of the extension member is constant.

Aspects of certain non-limiting embodiments of the present disclosure overcome the above disadvantages and/or other disadvantages not described above. However, aspects of the non-limiting embodiments are not required to overcome the disadvantages described above, and aspects of the non-limiting embodiments of the present disclosure may not overcome any of the disadvantages described above.

According to an aspect of the present disclosure, there is provided a sheet stacking section including a stacking portion that extends in one direction and on which a sheet member is stacked, an extension member that rotates about an axis along an intersection direction intersecting the one direction such that one end of the extension member moves on a trajectory upward and that moves between a storage position where the extension member is stored in the stacking portion and an extension position where the extension member protrudes from the stacking portion to extend the stacking portion, and an allowance portion that allows movement of a relative position between the axis and the stacking portion or movement of a relative position between the axis and the extension member such that, in a case where the extension member moves between the storage position and the extension position, a length of the extension member at a portion below a stacking surface of the stacking portion during the movement is longer than the length at beginning of the movement.

### BRIEF DESCRIPTION OF THE DRAWINGS

Exemplary embodiment(s) of the present invention will be described in detail based on the following figures, wherein:

FIG. 1 is a schematic configuration diagram showing an image forming apparatus according to a first exemplary embodiment of the present disclosure;

FIG. 2 is a schematic configuration diagram showing an image forming unit provided in the image forming apparatus according to the first exemplary embodiment of the present disclosure;

FIGS. 3A and 3B are perspective views showing a discharge tray according to the first exemplary embodiment of the present disclosure, in which a state where an extension member is moved to a storage position and a state where the extension member is moved to an extension position are shown;

FIG. 4 is an exploded perspective view showing the discharge tray according to the first exemplary embodiment of the present disclosure;

FIGS. 5A and 5B are front views showing the discharge tray according to the first exemplary embodiment of the present disclosure and showing a rotational position of the extension member in time series;

FIGS. 6A and 6B are front views showing the discharge tray according to the first exemplary embodiment of the present disclosure and showing a rotational position of the extension member in time series;

FIGS. 7A and 7B are front views showing the discharge tray according to the first exemplary embodiment of the present disclosure and showing a rotational position of the extension member in time series;

FIGS. 8A and 8B are front views showing the discharge tray according to a second exemplary embodiment of the present disclosure and showing a rotational position of the extension member;

FIGS. 9A and 9B are front views showing the discharge tray according to a third exemplary embodiment of the present disclosure and showing a state where the extension member further protrudes from a stacking portion;

FIGS. 10A and 10B are front views showing the discharge tray according to a fourth exemplary embodiment of the present disclosure and showing a rotational position of the extension member in time series;

FIGS. 11A and 11B are front views showing the discharge tray according to the fourth exemplary embodiment of the present disclosure and showing a rotational position of the extension member in time series;

FIGS. 12A and 12B are front views showing the discharge tray according to a fifth exemplary embodiment of the present disclosure and showing a rotational position of the extension member in time series;

FIGS. 13A and 13B are front views showing the discharge tray according to a sixth exemplary embodiment of the present disclosure and showing a rotational position of the extension member in time series;

FIGS. 14A and 14B are front views showing the discharge tray according to the sixth exemplary embodiment of the present disclosure and showing a rotational position of the extension member in time series; and

FIGS. 15A and 15B are front views showing the discharge tray according to a seventh exemplary embodiment of the present disclosure and showing a rotational position of the extension member in time series.

### DETAILED DESCRIPTION

### First Exemplary Embodiment

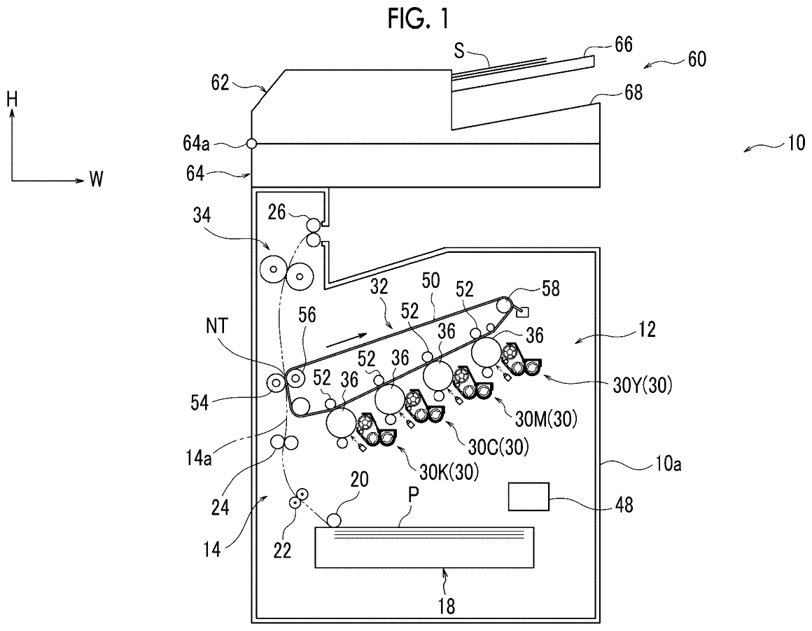

An example of a discharge section, a reading device, and an image forming apparatus according to a first exemplary embodiment of the present disclosure will be described with reference to FIG. 1 to FIGS. 7A and 7B. In addition, an arrow H shown in each drawing indicates a vertical direction and an up-down direction of the discharge section, the reading device, and the image forming apparatus. An arrow W is orthogonal to the arrow H and indicates a width direction of the discharge section, the reading device, and the image forming apparatus in a horizontal direction. An arrow D is orthogonal to the arrow H and the arrow W and indicates a depth direction of the discharge section, the reading device, and the image forming apparatus in the horizontal direction.

### Overall Configuration of Image Forming Apparatus 10

As shown in FIG. 1, an image forming apparatus 10 includes a reading device 60 that reads an image, an image forming section 12 that forms a toner image, and a transport section 14 that transports a sheet member P along a transport path 14a. In addition, the image forming apparatus 10 includes an accommodating member 18 that accommodates the sheet member P and a control unit 48 that controls the entire apparatus.

In this configuration, in the image forming apparatus 10, the sheet member P accommodated in the accommodating member 18 is transported by the transport section 14 along the transport path 14a. Further, a toner image is formed by the image forming section 12 based on image data of the image read by the reading device 60. In addition, this toner image is formed on the sheet member P being transported, and the sheet member P on which the toner image is formed is discharged to an outside of an apparatus body 10a.

### Image Forming Section 12

As shown in FIG. 1, the image forming section 12 includes a plurality of toner image forming units 30 that form toner images of respective colors and a transfer unit 32 that transfers the toner images formed by the toner image forming units 30 onto the sheet member P. Further, the image forming section 12 includes a fixing device 34 that fixes the toner images, which are transferred onto the sheet member P by the transfer unit 32, to the sheet member P.

### Toner Image Forming Unit 30

The plurality of toner image forming units 30 are provided to form toner images for respective colors. In the present exemplary embodiment, toner image forming units 30Y, 30M, 30C, and 30K for a total of four colors of yellow (Y), magenta (M), cyan (C), and black (K) are provided. In the following description, in a case where there is no need to distinguish between yellow (Y), magenta (M), cyan (C), and black (K), Y, M, C, and K attached as the reference numerals are omitted.

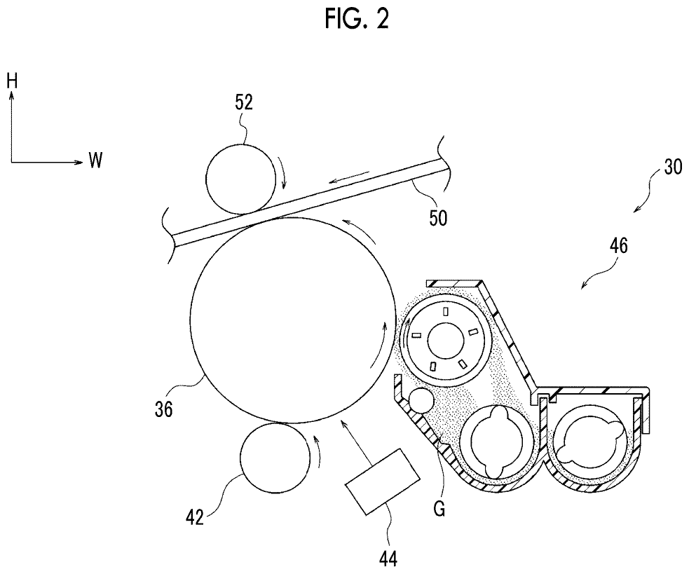

The toner image forming units 30 of the respective colors have the basically same configuration except for a toner to be used. As shown in FIG. 2, the toner image forming unit 30 includes a rotating image holder 36 that has a columnar shape and a charger 42 that charges the image holder 36. Further, the toner image forming unit 30 includes an exposure device 44 that irradiates the charged image holder 36 with exposure light to form an electrostatic latent image and a developing device 46 that develops the electrostatic latent image by using a developer G containing a toner as a toner image. As a result, the toner image forming unit 30 of each color forms an image of each color using a toner of each color.

In addition, as shown in FIG. 1, the image holder 36 of each color is in contact with a transfer belt 50 (described in detail below) that moves circumferentially. In a circumferential direction (see an arrow in the drawing) of the transfer belt 50, the yellow (Y), magenta (M), cyan (C), and black (K) toner image forming units 30 are arranged in turn from an upstream side.

### Transfer Unit 32

As shown in FIG. 1, the transfer unit 32 includes the transfer belt 50 and primary transfer rolls 52 each of which is disposed on an opposite side of the image holder 36 of each color with the transfer belt 50 interposed therebetween. The primary transfer roll 52 transfers the toner image formed on the image holder 36 of each color onto the transfer belt 50.

In addition, the transfer unit 32 includes a winding roll 56 around which the transfer belt 50 is wound, and a drive roll 58 around which the transfer belt 50 is wound and which transmits a rotational force to the transfer belt 50. As a result, the transfer belt 50 is circumferentially driven in an arrow direction in the drawing.

Further, the transfer unit 32 includes a secondary transfer roll 54 that is disposed on an opposite side of the winding roll 56 with the transfer belt 50 interposed therebetween. The secondary transfer roll 54 transfers the toner image transferred onto the transfer belt 50, onto the sheet member P. A transfer nip NT where the toner image is transferred onto the sheet member P is formed between the secondary transfer roll 54 and the transfer belt 50.

In this configuration, the toner image is primarily transferred onto the transfer belt 50 by the primary transfer rolls 52 in order of yellow (Y), magenta (M), cyan (C), and black (K). In addition, the toner image is transferred from the transfer belt 50 by the secondary transfer roll 54 onto the sheet member P transported while being interposed between the transfer belt 50 and the secondary transfer roll 54. Further, the sheet member P onto which the toner image is transferred is transported toward the fixing device 34.

### Fixing Device 34

As shown in FIG. 1, the fixing device 34 is disposed on a downstream side of the transfer nip NT in a transport direction of the sheet member P. The fixing device 34 heats and pressurizes the toner image transferred onto the sheet member P to fix the toner image to the sheet member P.

### Transport Section 14

As shown in FIG. 1, the transport section 14 includes a feeding roll 20 that feeds the sheet member P accommodated in the accommodating member 18 to the transport path 14a and a prevention roll 22 that prevents double-feeding of the sheet member P fed by the feeding roll 20. Further, the transport section 14 includes an adjustment roll 24 that adjusts a timing of the sheet member P being fed to the transfer nip NT. In addition, the transport section 14 includes a discharge roll 26 that discharges the sheet member P to which the toner image is fixed by the fixing device 34 to the outside of the apparatus body 10a.

### Reading Device 60

As shown in FIG. 1, the reading device 60 is disposed above the discharge roll 26 that discharges the sheet member P. The reading device 60 includes a document transport section 62 and a document reading section 64. In addition, the document transport section 62 and the document reading section 64 are connected by a hinge portion 64a provided in the document reading section 64. Further, the reading device 60 includes a supply tray 66 on which a document S to be supplied to the document transport section 62 is stacked, and a discharge tray 68 onto which the document S read by the document reading section 64 is discharged. The supply tray 66 and the discharge tray 68 are attached to the document transport section 62. Details of the discharge tray 68 will be described below.

In this configuration, the document transport section 62 rotates about the hinge portion 64a, so that an upper surface (platen glass) of the document reading section 64 is opened upward. Then, the document reading section 64 reads an image of the document S placed on a platen glass (not shown) disposed on the upper surface of the document reading section 64 and an image of the document S transported by the document transport section 62.

### Major Configuration

Next, the discharge tray 68 provided in the reading device 60 will be described.

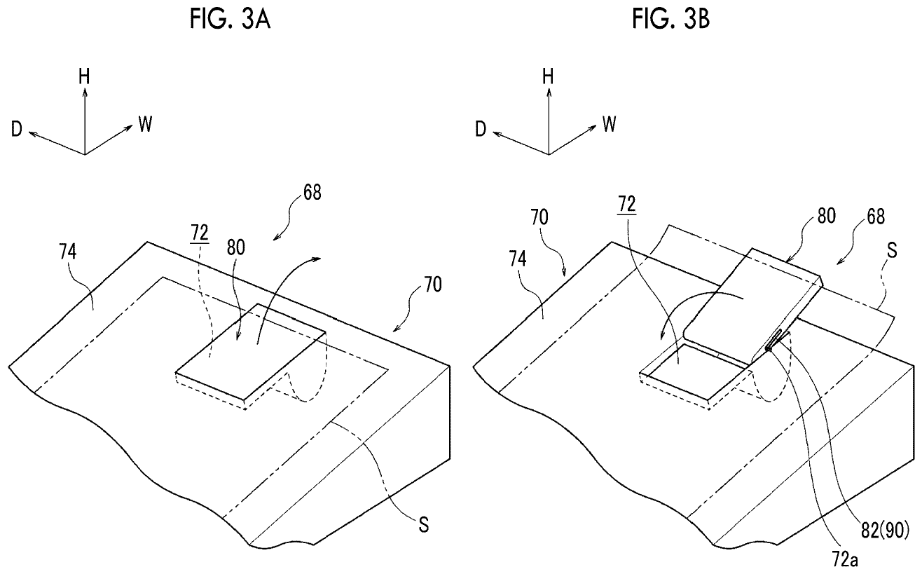

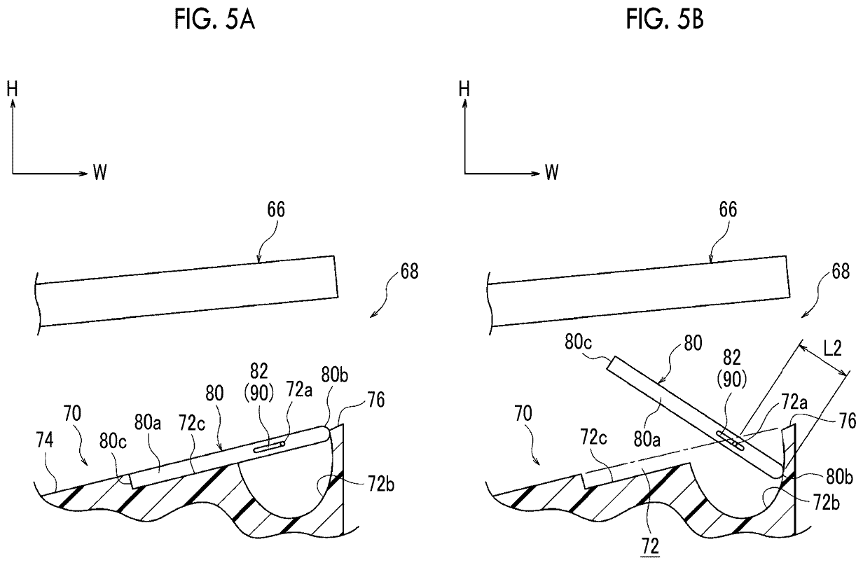

As shown in FIG. 1, the document S is discharged onto the discharge tray 68 from one side (left side in the drawing) in the width direction. Then, as shown in FIGS. 3A and 3B, the discharge tray 68 includes a stacking portion 70 on which the discharged document S is stacked. Further, the discharge tray 68 includes an extension member 80 that rotates and moves between a storage position (see FIG. 3A) where the discharge tray 68 is stored in the stacking portion 70 and an extension position (see FIG. 3B) where the discharge tray 68 protrudes from the stacking portion 70 to extend the stacking portion 70. In addition, the discharge tray 68 includes an allowance portion 90 that allows movement of a relative position between the extension member 80 and a rotation axis of the extension member 80. Further, as shown in FIGS. 5A and 5B, the discharge tray 68 includes a curved surface 72b that restricts a movement path of the extension member 80. The discharge tray 68 is an example of a sheet stacking section, and the document S is an example of a sheet member.

### Stacking Portion 70

As shown in FIGS. 1, 3A, and 3B, the stacking portion 70 extends in a direction (one direction) inclined with respect to the width direction such that a portion on the other side (right side in the drawing) in the width direction is positioned higher than a portion on the one side in the width direction. The stacking portion 70 has a stacking surface 74 on which the document S is stacked.

In addition, the stacking portion 70 is formed with a storage recess portion 72 for storing the extension member 80 moved to the storage position and a pair of shaft portions 72a protruding in the depth direction and having a columnar shape.

Storage Recess Portion 72 and Shaft Portion 72a

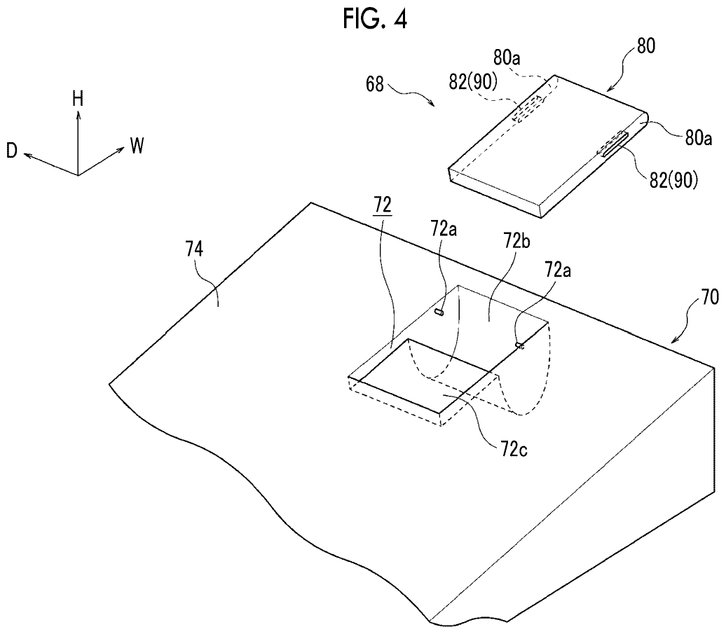

As shown in FIG. 4, the storage recess portion 72 is formed in a portion of the stacking portion 70 on the other side in the width direction, and has a rectangular shape extending in the width direction as viewed from above. Then, the extension member 80 moved to the storage position is stored in the storage recess portion 72 (see FIG. 3A).

The pair of shaft portions 72a are formed to protrude toward an inside of the storage recess portion 72 from a rear portion and a front portion in the depth direction of the storage recess portion 72. The shaft portion 72a has a columnar shape extending in the depth direction.

### Extension Member 80 and Allowance Portion 90

The extension member 80 has a plate shape as shown in FIGS. 3A and 3B, and has a rectangular shape extending in the width direction as viewed in a plate thickness direction.

As shown in FIG. 4, the allowance portion 90 includes a pair of recessed insertion portions 82 formed on a pair of side surfaces 80a of the extension member 80 facing the depth direction, respectively. The insertion portion 82 extends along a plate surface of the extension member 80. In other words, the insertion portion 82 extends along a direction (one direction) in which the extension member 80 extends in a state where the extension member 80 is disposed in the storage position. The shaft portion 72a of the stacking portion 70 is movably inserted into the insertion portion 82.

In this configuration, the extension member 80 rotates about an axis (rotation axis) along the depth direction intersecting the direction (one direction) in which the extension member 80 extends, and moves between the storage position and the extension position.

Curved Surface 72b

As shown in FIG. 4, the curved surface 72b is formed in the storage recess portion 72 of the stacking portion 70 and has a U-shape that is open upward. Then, as shown in FIGS. 5A and 5B, the extension member 80 is rotated while an end part 80b on the other side in the width direction of the rotating extension member 80 is brought into contact with the curved surface 72b, so that the curved surface 72b restricts the movement path of the extension member 80. The curved surface 72b is an example of a restricting portion, and the end part 80b is an example of the other end.

### Others

The discharge tray 68 includes a limiting portion 72c and a limiting portion 76 that limit a rotation range of the rotating extension member 80.

The limiting portion 72c is a portion that limits the rotation range of the rotating extension member 80 in order to dispose the rotating extension member 80 in the storage position. As shown in FIG. 5A, the limiting portion 72c is formed in the storage recess portion 72 of the stacking portion 70 and comes into contact with the plate surface of the extension member 80 moved to the storage position.

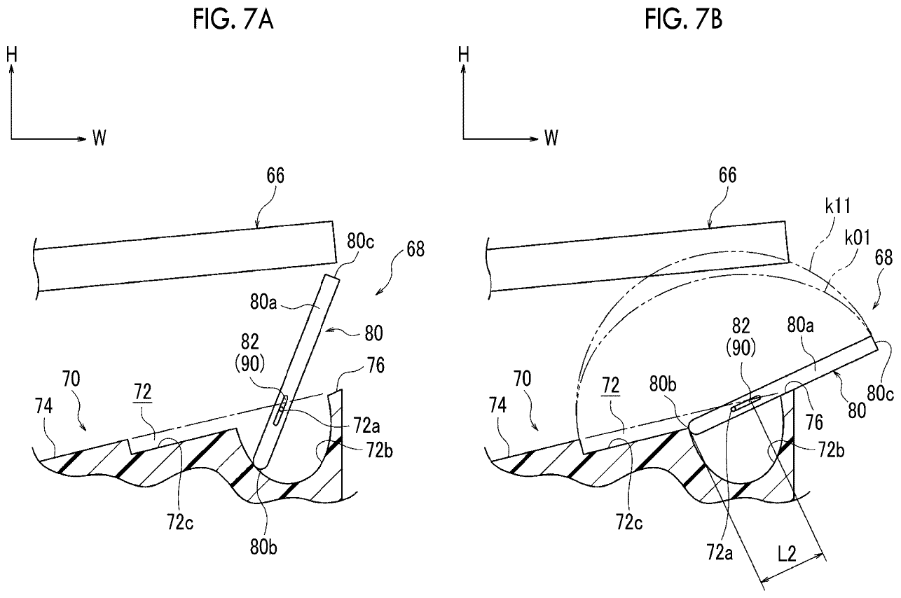

The limiting portion 76 is a portion that limits the rotation range of the rotating extension member 80 in order to dispose the rotating extension member 80 in the extension position. As shown in FIG. 7B, the limiting portion 76 is formed on the stacking portion 70 and comes into contact with the plate surface of the extension member 80 moved to the extension position.

### Action

Next, a step of moving the extension member 80 between the storage position and the extension position will be described.

As shown in FIG. 5A, in a state where the extension member 80 is disposed in the storage position, the shaft portion 72a is disposed in a portion of the insertion portion 82 on the end part 80b side.

Then, as shown in FIG. 5B, in a case where an end part 80c of the extension member 80 opposite to the end part 80b is lifted, the extension member 80 rotates about an axis extending in the depth direction. Specifically, the end part 80c of the extension member 80 is lifted while the end part 80b of the extension member 80 is brought into contact with the curved surface 72b. In addition, the shaft portion 72a moves from the portion on the end part 80b side to the end part 80c side in the insertion portion 82. In other words, the rotation axis of the extension member 80 moves relative to the extension member 80. The end part 80c is an example of one end.

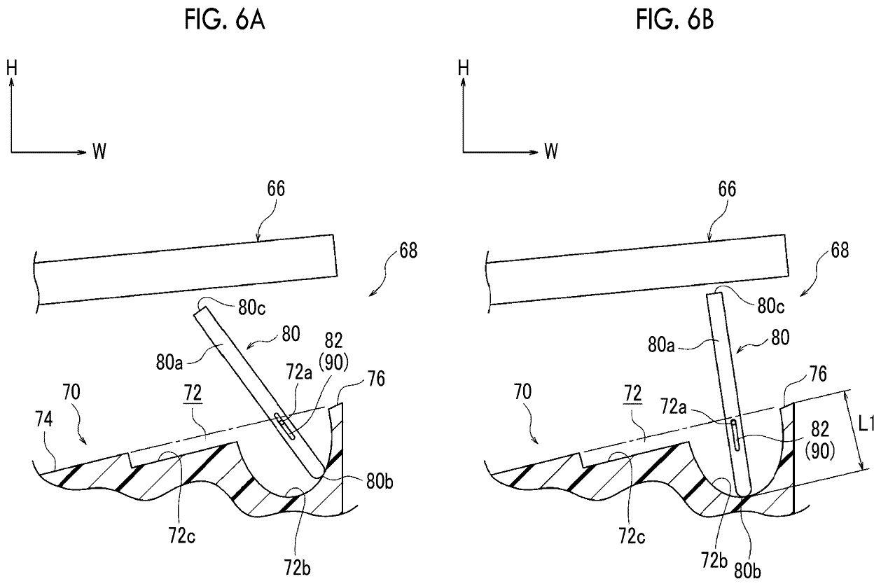

Further, as shown in FIGS. 6A and 6B, the extension member 80 is rotated counterclockwise such that the end part 80c of the extension member 80 moves on a trajectory. Specifically, the extension member 80 is rotated counterclockwise in a state where the end part 80b of the extension member 80 is maintained in contact with the curved surface 72b. In addition, the shaft portion 72a moves to the end part 80c side in the insertion portion 82.

Here, as shown in FIG. 6B, in a state where the end part 80c of the extension member 80 is closest to the supply tray 66, the shaft portion 72a is disposed in a portion of the insertion portion 82 on the end part 80c side.

Further, as shown in FIGS. 7A and 7B, the extension member 80 is rotated counterclockwise such that the end part 80c of the extension member 80 moves on a trajectory. Specifically, the extension member 80 is rotated counterclockwise in a state where the end part 80b of the extension member 80 is maintained in contact with the curved surface 72b. In addition, the shaft portion 72a moves from the portion on the end part 80c side to the end part 80b side in the insertion portion 82.

Then, as shown in FIG. 7B, the rotation of the extension member 80 is limited by the contact of the plate surface of the rotating extension member 80 with the limiting portion 76, and the extension member 80 is disposed in the extension position. In this state, the extension member 80 protrudes from the stacking portion 70 to the other side in the width direction to extend the stacking portion 70. In the present exemplary embodiment, the phrase “the extension member 80 extends the stacking portion 70” means that a stacking range of the document S that can be stacked on the stacking portion 70 is extended and widened.

Here, FIG. 7B shows a rotation trajectory K01 of the end part 80c of the extension member 80 and a rotation trajectory K11 of the end part of the extension member in a case where the rotation axis of the extension member 80 is fixed relative to the extension member 80. As can be seen by comparing the rotation trajectory K01 with the rotation trajectory K11, the highest position of the rotation trajectory K01 is lower than the highest position of the rotation trajectory K11. In other words, in a case where the extension member 80 moves between the storage position and the extension position, a length L1 (see FIG. 6B) of the extension member 80 at a portion below the stacking surface 74 of the stacking portion 70 during the movement is longer than a length L2 (see FIG. 5B and FIG. 7B) at the beginning of the movement.

In a case where the extension member 80 is moved from the extension position to the storage position, steps reverse to the above-described step order are performed.

### Second Exemplary Embodiment

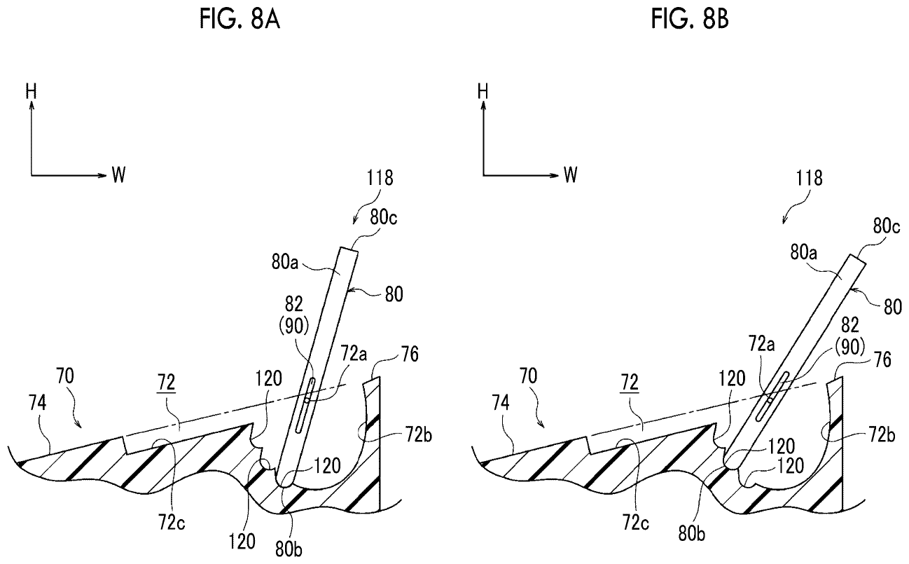

Next, a discharge section according to a second exemplary embodiment of the present disclosure will be described with reference to FIGS. 8A and 8B. The second exemplary embodiment will be described largely focusing on differences from the first exemplary embodiment.

As shown in FIGS. 8A and 8B, the curved surface 72b of a discharge section 118 according to the second exemplary embodiment is formed with a recess portion 120 having a concave shape into which the end part 80b of the extension member 80 is fitted. A plurality of the recess portions 120 are arranged in a circumferential direction of the curved surface 72b and extend in the depth direction.

In this configuration, the end part 80b of the extension member 80 in the middle of rotation is fitted to the recess portion 120, so that the extension member 80 is held at a position in the middle of rotation.

### Third Exemplary Embodiment

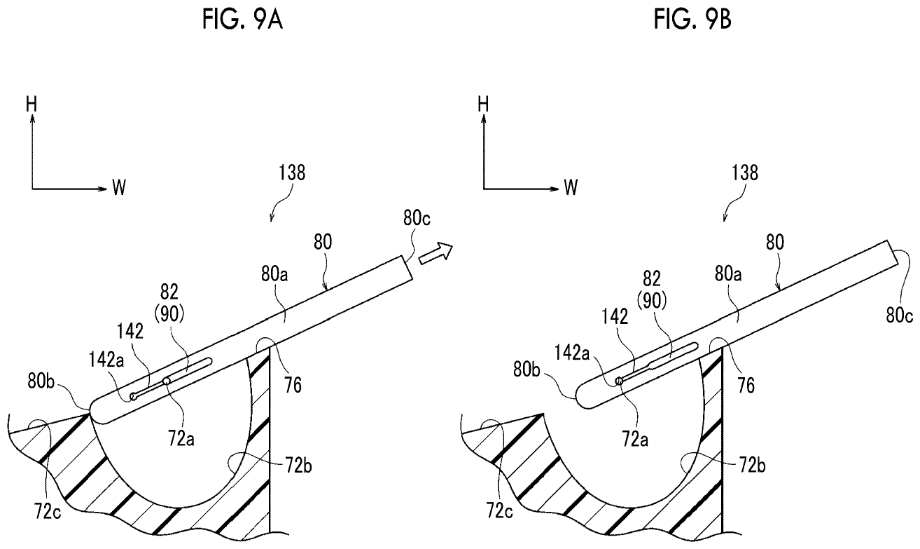

Next, a discharge section according to a third exemplary embodiment of the present disclosure will be described with reference to FIGS. 9A and 9B. The third exemplary embodiment will be described largely focusing on differences from the first exemplary embodiment.

As shown in FIG. 9A, the side surface 80a of the extension member 80 of a discharge section 138 according to the third exemplary embodiment is formed with the insertion portion 82 and a sliding groove 142. The sliding groove 142 extends from the insertion portion 82 to the end part 80b side of the extension member 80, and a groove width of the sliding groove 142 is narrower than a groove width of the insertion portion 82.

Specifically, the groove width of the sliding groove 142 is smaller than a shaft diameter of the shaft portion 72a. Then, the shaft portion 72a slidably moves in the sliding groove 142. In addition, a terminal part 142a that is wider than the groove width of the sliding groove 142 is formed at an end part of the sliding groove 142 opposite to the insertion portion 82.

In this configuration, as shown in FIG. 9A, in a state where the extension member 80 is disposed in the extension position, the extension member 80 is pulled in a direction in which the sliding groove 142 extends. Then, as shown in FIG. 9B, the shaft portion 72a moves while sliding in the sliding groove 142, and the extension member 80 further protrudes from the stacking portion 70 to the other side in the width direction.

In addition, an outer diameter of the terminal part 142a of the sliding groove 142 is larger than the groove width of the sliding groove 142.

### Fourth Exemplary Embodiment

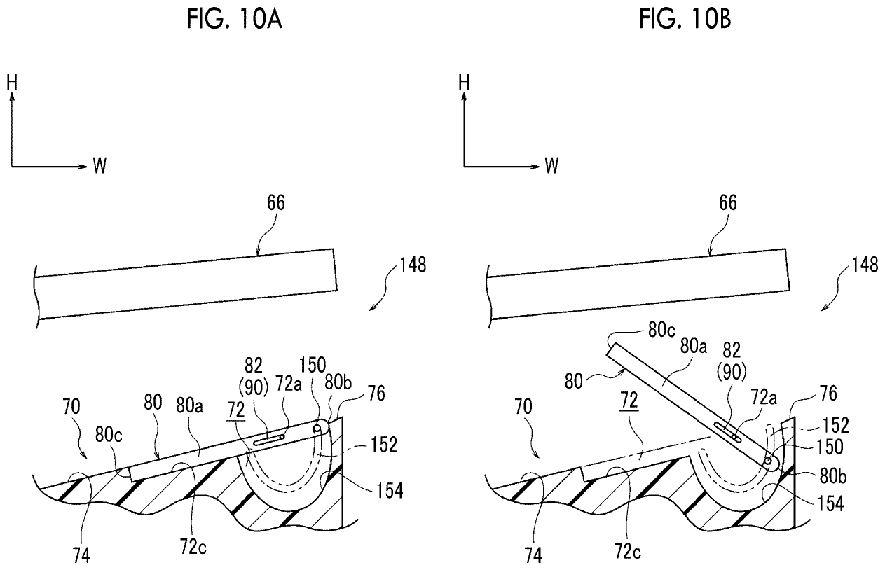

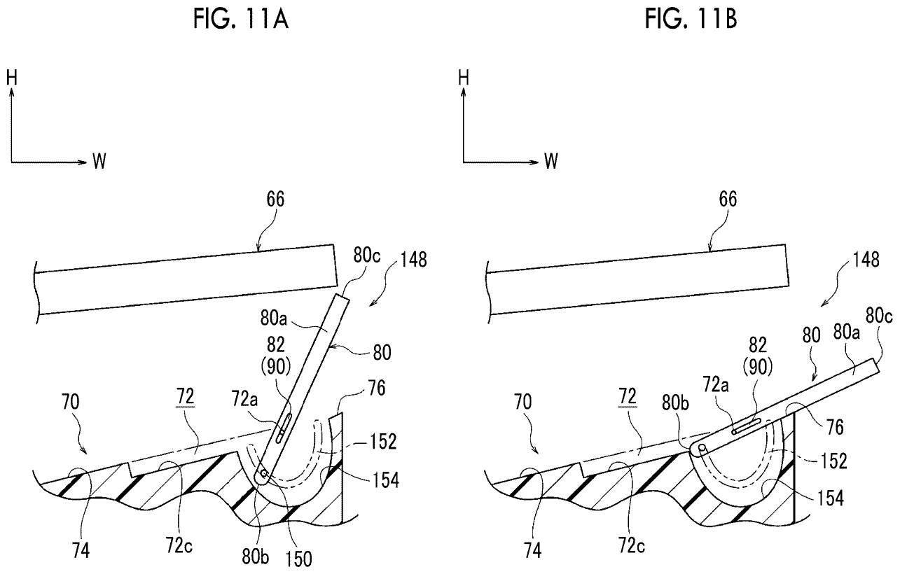

Next, a discharge section according to a fourth exemplary embodiment of the present disclosure will be described with reference to FIGS. 10A and 10B and FIGS. 11A and 11B. The fourth exemplary embodiment will be described largely focusing on differences from the first exemplary embodiment.

As shown in FIG. 10A, the side surface 80a of the extension member 80 of a discharge section 148 according to the fourth exemplary embodiment is formed with an extension portion 150. Further, a guide groove 152 for movably guiding the extension portion 150 is formed in the storage recess portion 72 of the stacking portion 70. In addition, a curved surface 154 formed in the storage recess portion 72 is larger than the curved surface 72b (see FIG. 5A) according to the first exemplary embodiment.

The extension portion 150 has a columnar shape extending in the depth direction. Specifically, the extension portion 150 is formed on the side surface 80a to extend in the depth direction from a portion on the end part 80b side relative to the insertion portion 82.

A pair of the guide grooves 152 are provided with the extension member 80 interposed therebetween. The guide groove 152 has a U-shape that is open upward.

In this configuration, as shown in FIGS. 10A and 10B and FIGS. 11A and 11B, in a case where the extension member 80 is rotated, the extension portion 150 moves in the guide groove 152. The end part 80b of the rotating extension member 80 and the curved surface 154 are spaced apart.

As described above, the extension portion 150 moves in the guide groove 152, thereby restricting the rotation of the extension member 80.

### Fifth Exemplary Embodiment

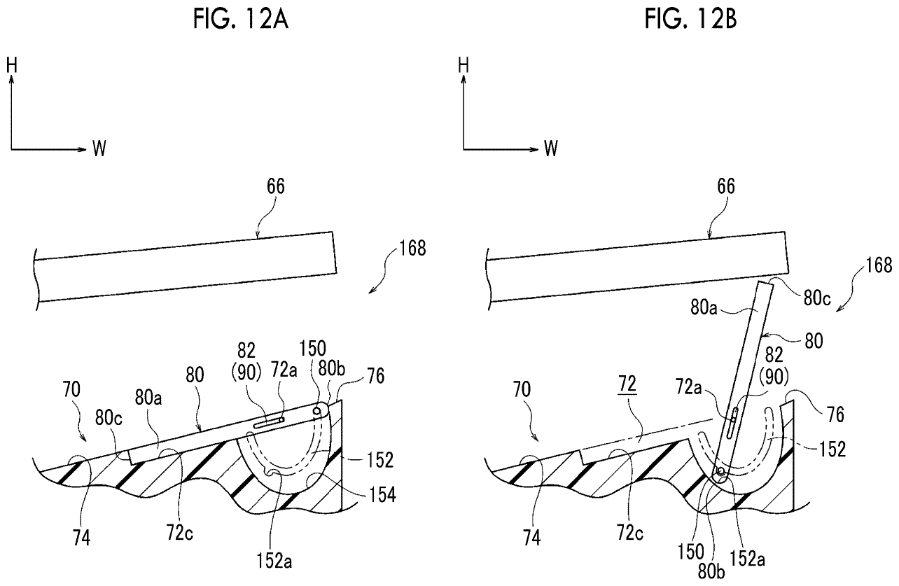

Next, a discharge section according to a fifth exemplary embodiment of the present disclosure will be described with reference to FIGS. 12A and 12B. The fifth exemplary embodiment will be described largely focusing on differences from the fourth exemplary embodiment.

As shown in FIG. 12A, the guide groove 152 of a discharge section 168 according to the fifth exemplary embodiment is formed with a recess portion 152a. By fitting the extension portion 150 of the rotating extension member 80 into the recess portion 152a, the extension member 80 is held at a position in the middle of rotation, as shown in FIG. 12B.

### Sixth Exemplary Embodiment

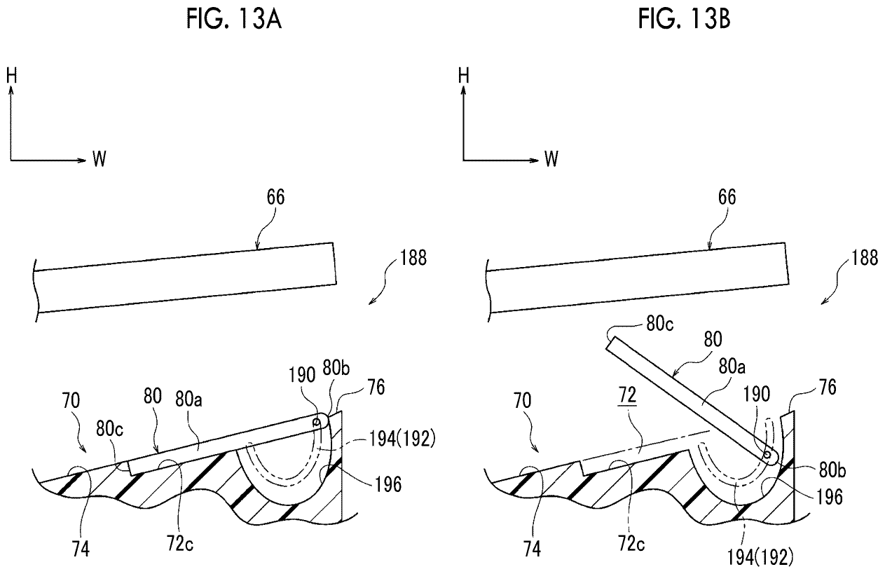

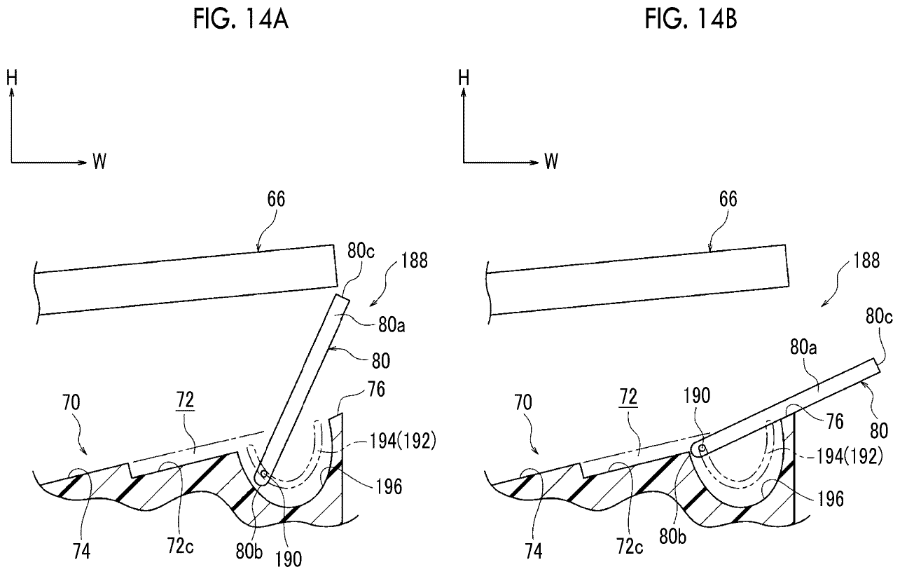

Next, a discharge section according to a sixth exemplary embodiment of the present disclosure will be described with reference to FIGS. 13A and 13B and FIGS. 14A and 14B. The sixth exemplary embodiment will be described largely focusing on differences from the first exemplary embodiment.

As shown in FIG. 13A, the side surface 80a of the extension member 80 of a discharge section 188 according to the sixth exemplary embodiment is not formed with an insertion portion. A shaft portion 190 that protrudes in the depth direction is formed on the side surface 80a of the extension member 80. Specifically, the shaft portion 190 is formed in a portion of the side surface 80a on the end part 80b side.

In addition, in the storage recess portion 72 of the stacking portion 70, a shaft portion is not formed, and a guide groove 194 for movably guiding the shaft portion 190 is formed. The guide groove 194 functions as an allowance portion 192 that allows the rotation axis of the extension member 80 to move relative to the stacking portion 70.

Further, a curved surface 196 formed in the storage recess portion 72 is larger than the curved surface 72b (see FIG. 5A) according to the first exemplary embodiment.

In this configuration, as shown in FIGS. 13A and 13B and FIGS. 14A and 14B, in a case where the extension member 80 is rotated, the shaft portion 190 moves in the guide groove 194. The end part 80b of the rotating extension member 80 and the curved surface 154 are spaced apart.

### Seventh Exemplary Embodiment

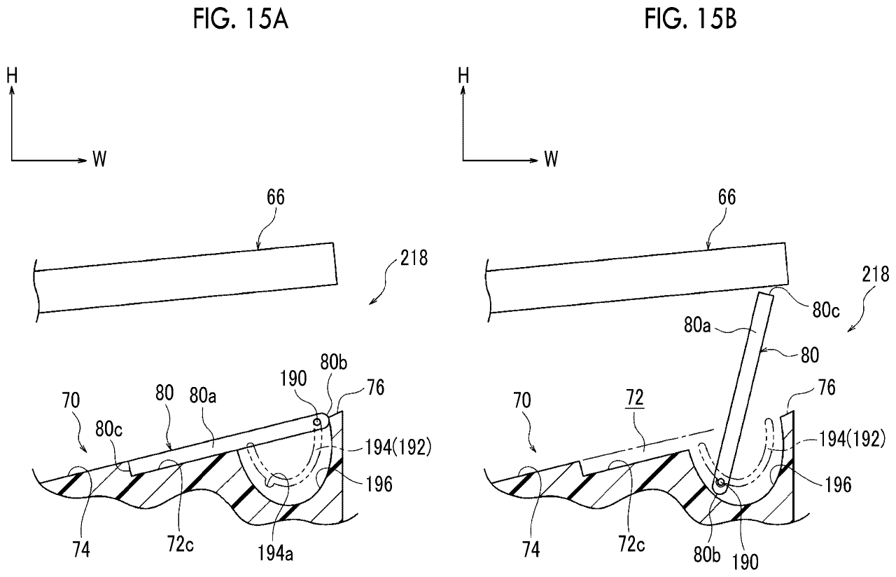

Next, a discharge section according to a seventh exemplary embodiment of the present disclosure will be described with reference to FIGS. 15A and 15B. The seventh exemplary embodiment will be described largely focusing on differences from the sixth exemplary embodiment.

As shown in FIG. 15A, the guide groove 194 of a discharge section 218 according to the seventh exemplary embodiment is formed with a recess portion 194a. By fitting the shaft portion 190 of the rotating extension member 80 into the recess portion 194a, the extension member 80 is held at a position in the middle of rotation, as shown in FIG. 15B.

Although the specific exemplary embodiments of the present disclosure are described in detail, the exemplary embodiment of the present disclosure is not limited to such exemplary embodiments, and it is apparent to those skilled in the art that various other exemplary embodiments can be taken within the scope of the present disclosure. The above-described exemplary embodiments are merely examples for description, and the present disclosure is not limited thereto. Modifications, additions, deletions, and combinations are possible as long as they do not deviate from the technical idea of the present invention that can be recognized by those skilled in the art from the description of the scope of the claims, the specification, and the drawings.

In addition, in the above-described exemplary embodiments, the discharge tray has been described as an example, but a sheet stacking section on which a sheet-shaped sheet member is stacked need only be used, and the configuration of the present disclosure may be used for a paper feed table or the like.

In addition, in the above-described exemplary embodiments, the extension member 80 has a flat plate shape, but may have a curved shape.

In addition, in the above-described exemplary embodiments, one extension member 80 is provided, but two extension members 80 may be provided to be spaced apart from each other in the depth direction.

In addition, in the first to fifth exemplary embodiments, the pair of insertion portions 82 are formed on the side surfaces 80a, respectively, but the pair of insertion portions 82 may be connected at the bottom of the pair of insertion portions 82.

(((1)))

A sheet stacking section comprising:
a stacking portion that extends in one direction and on which a sheet member is stacked;
an extension member that rotates about an axis along an intersection direction intersecting the one direction such that one end of the extension member moves on a trajectory upward and that moves between a storage position where the extension member is stored in the stacking portion and an extension position where the extension member protrudes from the stacking portion to extend the stacking portion; and
an allowance portion that allows movement of a relative position between the axis and the stacking portion or movement of a relative position between the axis and the extension member such that, in a case where the extension member moves between the storage position and the extension position, a length of the extension member at a portion below a stacking surface of the stacking portion during the movement is longer than the length at beginning of the movement.
   (((2)))

The sheet stacking section according to (((1))),
wherein shaft portions that extend in the intersection direction are formed in the stacking portion, toward the extension member from both sides of the intersection direction, and
the allowance portion includes insertion portions that are formed on both sides of the extension member in the intersection direction, the insertion portions extending in the one direction and into which the shaft portions are movably inserted in a state where the extension member is disposed at the storage position.
   (((3)))

The sheet stacking section according to (((2))), further comprising:
a restricting portion that restricts a movement path of the extension member.
   (((4)))

The sheet stacking section according to (((3))),
wherein the restricting portion is formed on the stacking portion and is a U-shaped curved surface that comes into contact with the other end of the rotating extension member and that is open upward as viewed in the intersection direction.
   (((5)))

The sheet stacking section according to (((4))),

wherein the curved surface is formed with a recess portion having a concave shape into which the other end of the extension member is fitted.
(((6)))

The sheet stacking section according to any one of (((2))) to (((5))),
wherein each of the insertion portions formed in the extension member has a groove shape, and
the extension member is formed with a sliding groove that has a groove width narrower than a groove width of the insertion portion, the sliding groove extending from the insertion portion to a side of the other end of the extension member and allowing a shaft portion to slide therein.
   (((7)))

The sheet stacking section according to (((6))),

wherein an end part of the sliding groove opposite to the insertion portion is wider than the groove width of the sliding groove.
(((8)))

The sheet stacking section according to (((1))),
wherein shaft portions that extend outward in the intersection direction are formed in the extension member, toward the stacking portion from both sides of the intersection direction, and
the allowance portion includes guide grooves that are formed on both sides of the stacking portion in the intersection direction to interpose the extension member therebetween and that are used for guiding the shaft portions, the guide grooves into which the shaft portions are inserted and being open upward as viewed in the intersection direction, forming a U-shape.
   (((9)))

The sheet stacking section according to (((8))),
wherein the guide grooves are each formed with a recess portion having a concave shape into which a shaft portion is fitted.
   (((10)))

A reading device comprising:
a transport section that transports a document;
a supply tray on which the document to be supplied to the transport section is placed;
a reading section that reads an image formed on the document transported by the transport section; and
the sheet stacking section according to any one of (((1))) to (((9))) that is disposed below the supply tray and onto which the document transported by the transport section is discharged.
   (((11)))

An image forming apparatus comprising:
the reading device according to (((10))); and
an image forming section that forms an image read by the reading device.

The foregoing description of the exemplary embodiments of the present invention has been provided for the purposes of illustration and description. It is not intended to be exhaustive or to limit the invention to the precise forms disclosed. Obviously, many modifications and variations will be apparent to practitioners skilled in the art. The embodiments were chosen and described in order to best explain the principles of the invention and its practical applications, thereby enabling others skilled in the art to understand the invention for various embodiments and with the various modifications as are suited to the particular use contemplated. It is intended that the scope of the invention be defined by the following claims and their equivalents.

What is claimed is:

1. A sheet stacking section comprising:
a stacking portion that extends in one direction and on which a sheet member is stacked;
an extension member that rotates about an axis along an intersection direction intersecting the one direction such that one end of the extension member moves on a trajectory upward and that moves between a storage position where the extension member is stored in the stacking portion and an extension position where the extension member protrudes from the stacking portion to extend the stacking portion; and
an allowance portion that allows movement of a relative position between the axis and the stacking portion or movement of a relative position between the axis and the extension member such that, in a case where the extension member moves between the storage position and the extension position, a length of the extension member at a portion below a stacking surface of the stacking portion during the movement is longer than the length at beginning of the movement.

2. The sheet stacking section according to claim 1,
wherein shaft portions that extend in the intersection direction are formed in the stacking portion, toward the extension member from both sides of the intersection direction, and
the allowance portion includes insertion portions that are formed on both sides of the extension member in the intersection direction, the insertion portions extending in the one direction and into which the shaft portions are movably inserted in a state where the extension member is disposed at the storage position.

3. The sheet stacking section according to claim 2, further comprising:
a restricting portion that restricts a movement path of the extension member.

4. The sheet stacking section according to claim 3,
wherein the restricting portion is formed on the stacking portion and is a U-shaped curved surface that comes into contact with the other end of the rotating extension member and that is open upward as viewed in the intersection direction.

5. The sheet stacking section according to claim 4,
wherein the curved surface is formed with a recess portion having a concave shape into which the other end of the extension member is fitted.

6. The sheet stacking section according to claim 2,
wherein each of the insertion portions formed in the extension member has a groove shape, and
the extension member is formed with a sliding groove that has a groove width narrower than a groove width of the insertion portion, the sliding groove extending from the insertion portion to a side of the other end of the extension member and allowing a shaft portion to slide therein.

7. The sheet stacking section according to claim 6,
wherein an end part of the sliding groove opposite to the insertion portion is wider than the groove width of the sliding groove.

8. The sheet stacking section according to claim 1,
wherein shaft portions that extend outward in the intersection direction are formed in the extension member, toward the stacking portion from both sides of the intersection direction, and
the allowance portion includes guide grooves that are formed on both sides of the stacking portion in the intersection direction to interpose the extension member therebetween and that are used for guiding the shaft portions, the guide grooves into which the shaft portions are inserted and being open upward as viewed in the intersection direction, forming a U-shape.

9. The sheet stacking section according to claim 8,
wherein the guide grooves are each formed with a recess portion having a concave shape into which a shaft portion is fitted.

10. A reading device comprising:
a transport section that transports a document;
a supply tray on which the document to be supplied to the transport section is placed;
a reading section that reads an image formed on the document transported by the transport section; and
the sheet stacking section according to claim 1 that is disposed below the supply tray and onto which the document transported by the transport section is discharged.

11. A reading device comprising:
a transport section that transports a document;
a supply tray on which the document to be supplied to the transport section is placed;
a reading section that reads an image formed on the document transported by the transport section; and
the sheet stacking section according to claim 2 that is disposed below the supply tray and onto which the document transported by the transport section is discharged.

12. A reading device comprising:
a transport section that transports a document;
a supply tray on which the document to be supplied to the transport section is placed;
a reading section that reads an image formed on the document transported by the transport section; and
the sheet stacking section according to claim 3 that is disposed below the supply tray and onto which the document transported by the transport section is discharged.

13. A reading device comprising:
a transport section that transports a document;
a supply tray on which the document to be supplied to the transport section is placed;
a reading section that reads an image formed on the document transported by the transport section; and
the sheet stacking section according to claim 4 that is disposed below the supply tray and onto which the document transported by the transport section is discharged.

14. A reading device comprising:
a transport section that transports a document;
a supply tray on which the document to be supplied to the transport section is placed;
a reading section that reads an image formed on the document transported by the transport section; and
the sheet stacking section according to claim 5 that is disposed below the supply tray and onto which the document transported by the transport section is discharged.

15. A reading device comprising:
a transport section that transports a document;
a supply tray on which the document to be supplied to the transport section is placed;
a reading section that reads an image formed on the document transported by the transport section; and
the sheet stacking section according to claim 6 that is disposed below the supply tray and onto which the document transported by the transport section is discharged.

16. A reading device comprising:
a transport section that transports a document;
a supply tray on which the document to be supplied to the transport section is placed;
a reading section that reads an image formed on the document transported by the transport section; and
the sheet stacking section according to claim 7 that is disposed below the supply tray and onto which the document transported by the transport section is discharged.

17. A reading device comprising:
a transport section that transports a document;
a supply tray on which the document to be supplied to the transport section is placed;
a reading section that reads an image formed on the document transported by the transport section; and
the sheet stacking section according to claim 8 that is disposed below the supply tray and onto which the document transported by the transport section is discharged.

18. A reading device comprising:
a transport section that transports a document;
a supply tray on which the document to be supplied to the transport section is placed;
a reading section that reads an image formed on the document transported by the transport section; and
the sheet stacking section according to claim 9 that is disposed below the supply tray and onto which the document transported by the transport section is discharged.

19. An image forming apparatus comprising:
the reading device according to claim 10; and
an image forming section that forms an image read by the reading device.

20. An image forming apparatus comprising:
the reading device according to claim 11; and
an image forming section that forms an image read by the reading device.
